(19) United States
(12) Patent Application Publication
(10) Pub. No.: US 2025/0262730 A1
(43) Pub. Date: Aug. 21, 2025

(54) INLET GUIDE VANE SEGMENT PIN REMOVAL KIT

(71) Applicant: GE Infrastructure Technology LLC, Greenville, SC (US)

(72) Inventors: Karol TUCKI, Warsaw (PL); Mateusz KORUS, Warsaw (PL); Lukasz SAJDAK, Warsaw (PL); Michal KOWALCZYK, Warsaw (PL); Piotr WOJCIECHOWSKI, Warsaw (PL)

(21) Appl. No.: 19/055,208

(22) Filed: Feb. 17, 2025

(30) Foreign Application Priority Data
Feb. 20, 2024 (PL) P.447822

(51) Int. Cl. B25B 27/02; F01D 9/04

(52) U.S. Cl. CPC B25B 27/023; F01D 9/041; F05D 2230/70; F05D 2260/31

(57) ABSTRACT

An inlet guide vane segment pin removal kit for removal of an inlet guide vane pin with a head having a recess therein from an inlet guide vane segment. The inlet guide vane segment pin removal kit may include a bolt, a first wrench for inserting the bolt into the recess of the inlet guide vane pin, and a second wrench with an interior bore such that torqueing the second wrench draws the bolt and the inlet guide vane pin into the interior bore.

### CROSS-REFERENCE TO RELATED APPLICATION

This application claims priority pursuant to 35 U.S.C. 119(a) to Polish Application No. P.447822, filed Feb. 20, 2024, which application is incorporated herein by reference in its entirety.

### TECHNICAL FIELD

The invention relates generally to gas turbine engines and more particularly relates to an inlet guide vane segment pin removal kit to remove segment pins from an inlet guide vane segment attached to a lower half of a compressor inner casing without removing the rotor.

### BACKGROUND

In a gas turbine engine, the compressor draws in a flow of air. This flow of air may be guided therein by a number of inlet guide vanes. The inlet guide vanes may be arranged circumferentially about an inlet of the compressor. Specifically, known inlet guide vanes may be supported in two semi-annular halves of the turbine assembly, such as within an upper and lower inlet casing. Removal and replacement of the inlet guide vanes in the upper inlet casing may be accomplished relatively easily using known tools. Removal and replacement of the inlet guide vanes in the lower inlet casing, however, may be difficult. Access is limited due to space limitations such that the entire rotor and other types of equipment must be removed. Thus, removing the inlet guide vanes in the lower inlet casing may be challenging, time consuming, and expensive with known tools and methods.

### SUMMARY

The invention thus provides an inlet guide vane segment pin removal kit for removal of an inlet guide vane pin with a head having a recess therein from an inlet guide vane segment. The inlet guide vane segment pin removal kit may include a bolt, a first wrench for inserting the bolt into the recess of the inlet guide vane pin, and a second wrench with an interior bore such that torqueing the second wrench draws the bolt and the inlet guide vane pin into the interior bore.

The invention further provides a method of removing an inlet guide vane segment pin with a head having a recess therein from an inlet guide vane segment. The method may include the steps of inserting a bolt into the recess of the inlet guide vane segment pin, attaching a wrench with an interior bore to the bolt, and torqueing the wrench so as to drive the bolt and the inlet guide vane segment pin into the interior bore of the wrench.

The invention further provides an inlet guide vane segment pin removal kit for removal of an inlet guide vane pin with a head having a recess therein from an inlet guide vane segment. The inlet guide vane removal kit may include a bolt with a first portion and an second portion, a bolt insertion wrench for inserting the second portion of the bolt into the recess of the inlet guide vane pin, and a pin puller wrench with an interior bore sized to accept the first portion of the bolt such that torqueing the pin puller wrench draws the bolt and the inlet guide vane pin into the interior bore.

These and other features and improvements of this invention will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of an exemplary gas turbine engine including a compressor with a number of inlet guide vanes, a combustor, a turbine, a rotor shaft, and an external load;

FIG. 2 is a perspective view of a number of inlet guide vanes extending between an inner casing an outer casing;

FIG. 3 is a perspective view of an inlet guide vane segment with pins and bolts;

FIG. 4 is a perspective view of a banana bolt insertion wrench of the inlet guide vane segment pin removal kit as may be described herein;

FIG. 5 is a sectional view of the banana bolt insertion wrench of FIG. 4 with a sprocket and a bolt within an insertion socket;

FIG. 6 is a plan view of the bolt for use with the banana bolt insertion wrench of FIG. 4;

FIG. 7 is a perspective view of a pin puller wrench of the inlet guide vane segment pin removal kit as may be described herein;

FIG. 8 is a sectional view of the pin puller wrench of FIG. 7 with a sprocket having an interior bore;

FIG. 9 is a sectional view showing the inlet guide vane segment pin removal kit is use;

FIG. 10 is a sectional view showing the inlet guide vane segment pin removal kit is use;

FIG. 11 is a sectional view showing the inlet guide vane segment pin removal kit is use; and,

FIG. 12 is a sectional view showing the inlet guide vane segment pin removal kit is use.

### DETAILED DESCRIPTION

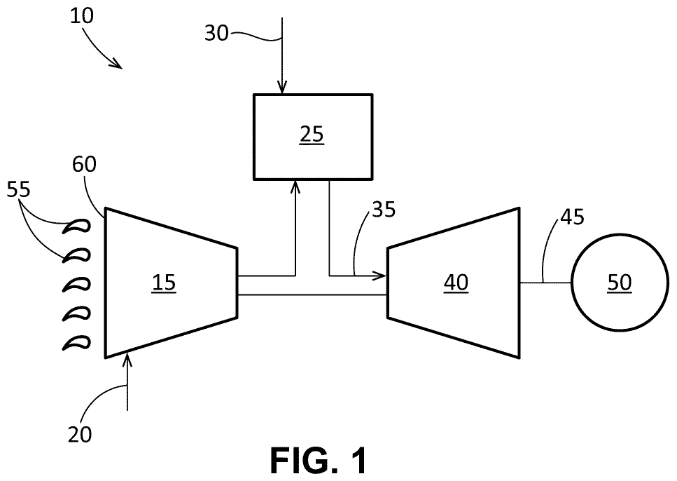

Referring now to the drawings, in which like numerals refer to like elements throughout the several views, FIG. 1 shows a schematic diagram of a gas turbine engine 10 as may be used herein. The gas turbine engine 10 may include a compressor 15. The compressor 15 compresses an incoming flow of air 20. The compressor 15 delivers the compressed flow of air 20 to a combustor 25 (e.g., multiple combustor cans). Each combustor can 25 mixes the compressed flow of air 20 with a pressurized flow of fuel 30 and ignites the mixture to create a flow of hot combustion gases 35. Although only a single combustor can 25 is shown, the gas turbine engine 10 may include any number of combustor cans 25 positioned in a circumferential array around a rotor 45. Alternatively, the combustor 25 may be an annular combustor. The flow of the hot combustion gases 35 is in turn delivered to a turbine 40. The flow of the hot combustion gases 35 drives the turbine 40 to produce mechanical work. The mechanical work produced in the turbine 40 drives, via the rotor 45, the compressor 15, and an external load 50, such as an electrical generator and the like.

The gas turbine engine 10 may use natural gas, various types of syngas, liquid fuels, and/or other types of fuels and blends thereof. The gas turbine engine 10 may be any one of a number of different gas turbine engines offered by General Electric Company of Schenectady, New York, including, but not limited to, those such as a 7-series or a 9-series heavy duty gas turbine engine and the like. The gas turbine engine 10 may have different configurations and may use other types of components. The present inlet guide vane segment pin removal kit also may be used with other types of gas turbine engines. Multiple gas turbine engines, other types of turbines, and other types of power generation equipment also may be used herein together.

Load control for the gas turbine engine 10 may be provided in part by a number of inlet guide vanes 55. As described above, the inlet guide vanes 55 may be positioned circumferentially about an inlet 60 of the compressor 15. Specifically, the output of the gas turbine engine 10 may be modulated by changing the position of the inlet guide vanes 55 so as to vary the amount of air entering the compressor 15. Any number of inlet guide vanes 55 may be used herein.

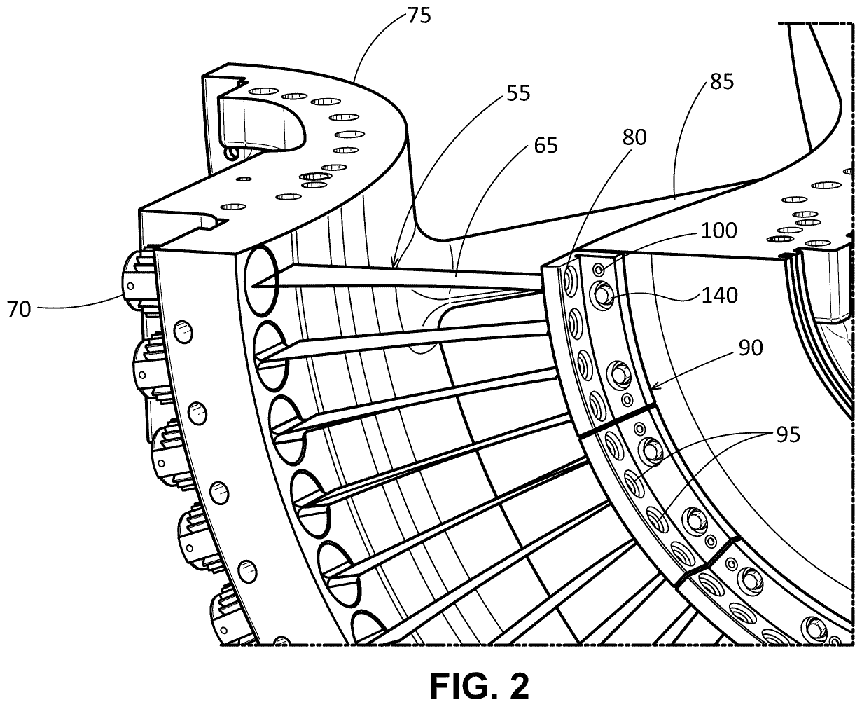

FIG. 2 shows the inlet guide vanes 55 in more detail. Each inlet guide vane 55 may have an airfoil portion 65 that extends from a drive gear 70 positioned about an outer casing 75 to a bushing 80 that is connected to an inner casing 85 via an inlet guide vane segment 90. Each inlet guide vane segment 90 may be substantially “L”-like in shape and may have a number of bores 95 therein for the bushings 80 and the other components described below. In this case, a lower half 98 of the inner casing 85 is shown.

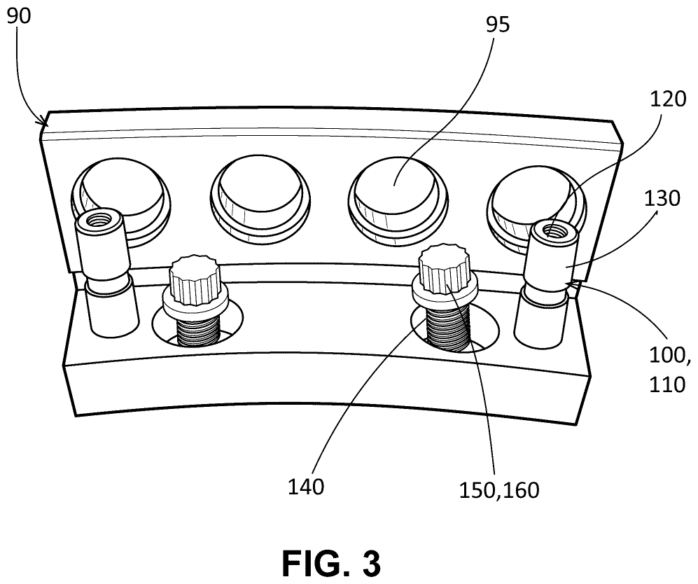

As is shown in FIGS. 2 and 3, each inlet guide vane segment 90 may be attached to the inner casing 85 via a pair of inlet guide vane segment pins 100. Specifically, the inlet guide vane segment pins 100 may be a pair of pull-out dowel pins 110. The inlet guide vane segment pins 100 may have a recess 120 on one end with a number of pin threads 130 therein. The inlet guide vane segments 90 also may be attached to the inner casing 85 via a pair of inlet guide vane segment bolts 140 and the like. The inlet guide vane segment bolts 140 may have a head 150 with a number of points 160 thereon. Other types of fasteners may be used herein. Other components and other configurations may be used herein.

When repair or replacement is required or scheduled, the inlet guide vane segment pins 100 may be removed from the inlet guide vane segments 90 via an inlet guide vane segment pin removal kit 170. An inlet guide vane segment pin removal kit 170 may include two custom tools, a “banana” bolt insertion wrench 180 and a pin puller wrench 190. The shape of respective tools 180, 190 allows access to the inlet guide vane segment pins 100 despite the limited distance between the inlet guide vane segment pins 100 and the rotor 45.

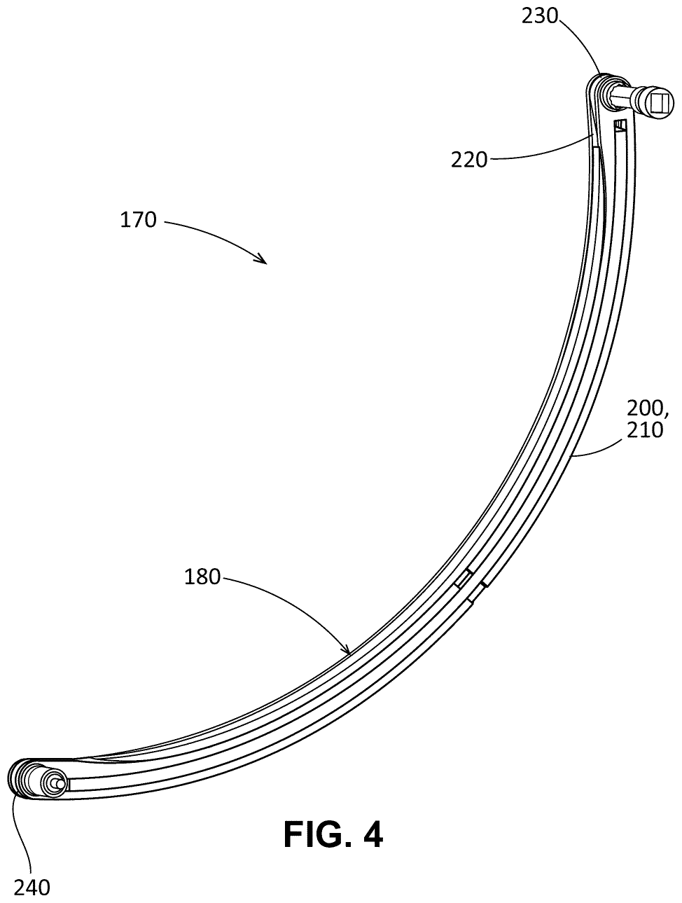

FIGS. 4-6 show examples of the banana bolt insertion wrench 180. The banana bolt insertion wrench 180 may have a hollow insertion body 200 with a substantially curved shape 210. As the name implies, the substantially curved shape 210 of the hollow insertion body 200 may be “banana”-like in shape. (The color is optional.) A rotating chain 220 may be positioned within the hollow insertion body 200. The rotating chain 220 may extend from a first sprocket 230 to a second sprocket 240. The sprockets 230, 240 include a number of teeth 250 that cooperate with a number of links 260 in the chain 220 for rotation therewith. Sprockets 230, 240 may rotate and apply torque in only one direction via a clutch or a similar mechanism. The first sprocket 230 may have an interior bore 270. An insertion socket 280 may be positioned within the interior bore 270. The insertion socket 280 may have a first end 290 in communication with a drive rod 300 of the first sprocket 230, and a second end 310 with a substantially square drive adapter 320 for use as described below. Other components and other configurations may be used herein.

The banana bolt insertion wrench 180 may be used to insert a custom bolt 330. The custom bolt 330 may have a first portion 340 sized to mate with the drive adapter 320 of the banana bolt insertion wrench 180. The first portion 340 also may have a number of first portion threads 350 sized to mate with the pin puller wrench 190 as will be described below. The custom bolt 330 also has a second portion 360 with a number of second portion threads 370 sized to mate with the pin threads 130 in the recess 120 of the inlet guide vane segment pins 100. Other components and other configurations may be used herein.

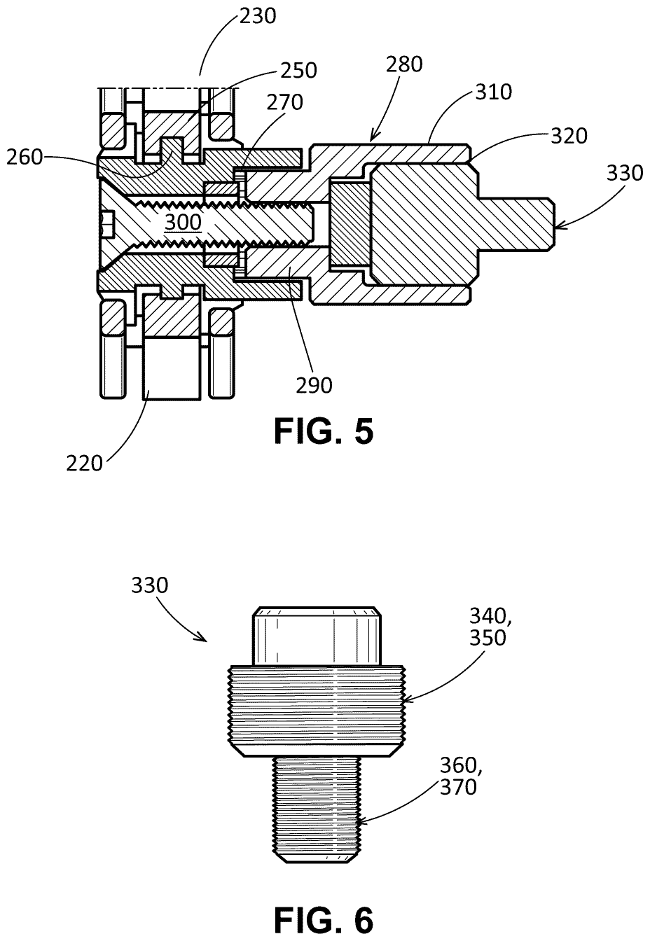

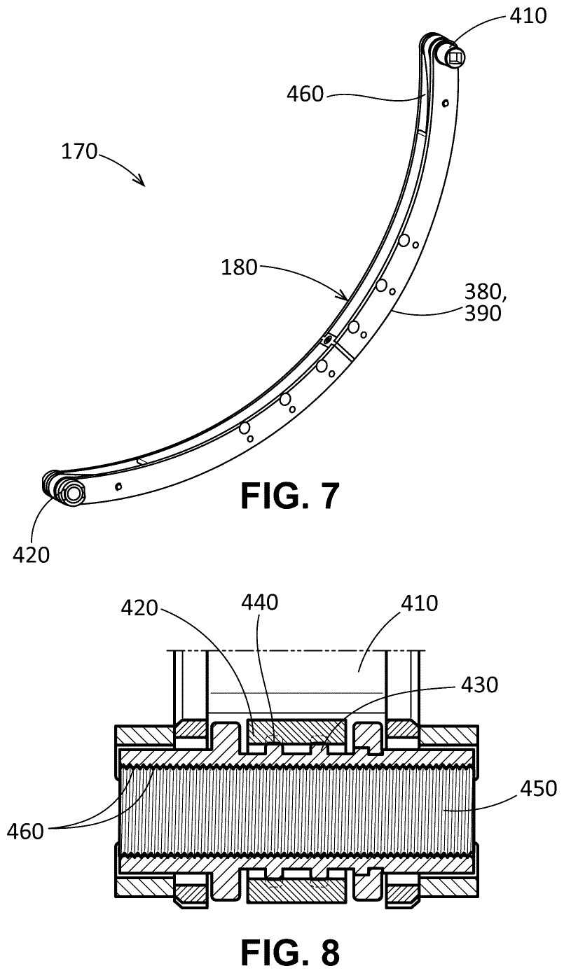

FIGS. 7 and 8 show an example of the pin puller wrench 190. The pin puller wrench 190 may have a pin puller hollow body 380 with a substantially curved shape 390. Similar to the banana bolt insertion wrench 180, the substantially curved shape 390 of the pin puller hollow body 380 also may be “banana”-like in shape. (The color is optional.) A rotating chain 400 may be positioned within the pin puller hollow body 380. The rotating chain 400 may extend from a first sprocket 410 to a second sprocket 420. The sprockets 410, 420 include a number of teeth 430 that cooperate with a number of links 440 in the chain 400 for rotation therewith. The sprockets 410, 420 may rotate and apply torque in only one direction via a clutch or a similar mechanism. The first sprocket 410 may have an interior bore 450 with a number of sprocket threads 460 formed therein. The sprocket threads 460 may be sized to mate with the first portion threads 350 of the custom bolt 330. Other components and other configurations may be used herein.

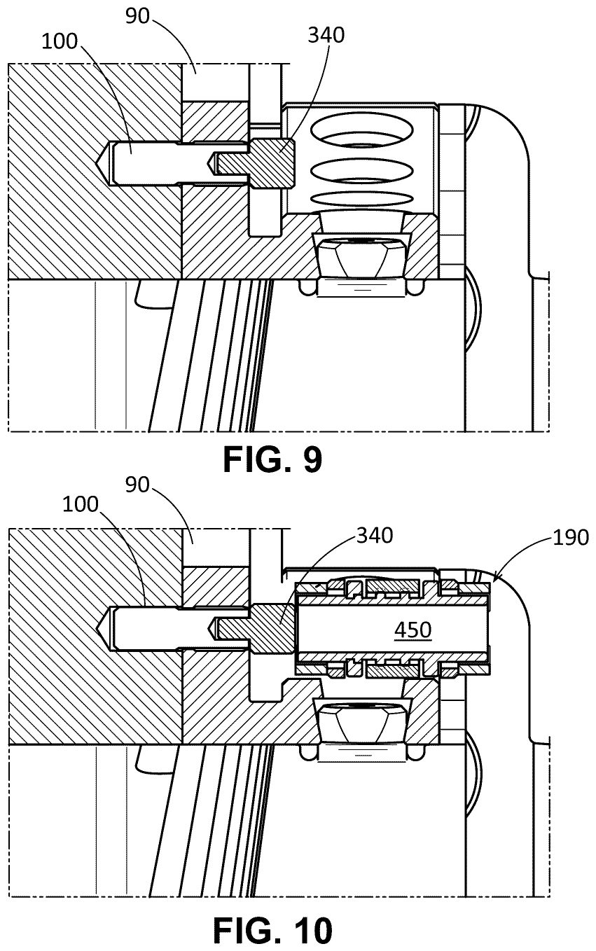

FIGS. 9-12 show the use of the inlet guide vane segment pin removal kit in operation. In FIG. 9, the first portion of the custom bolt 330 is inserted within the insertion socket 280 of the banana bolt insertion wrench 180. The banana bolt insertion wrench 180 is positioned about the inlet guide vane segment pin 100 such that the second portion threads 370 of the second portion 360 of the custom bolt 330 come in contact with the pin threads 130 of the recess 120 of the inlet guide vane segment pin 100. The banana bolt insertion wrench 180 is then torqued so as to drive the custom bolt 330 into the recess 120 of the inlet guide vane segment pin 100. The banana bolt insertion wrench 180 may then be removed.

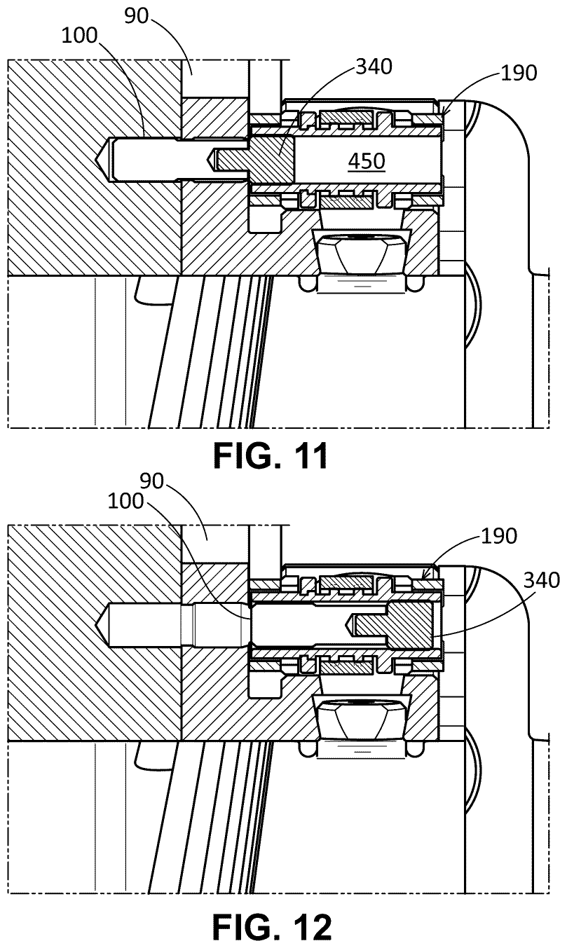

In FIG. 10, the pin puller wrench 190 may be positioned about the custom bolt 330 inserted within the recess 120 of the inlet guide vane segment pin 100. Specifically, the first portion threads 350 of the first portion 340 of the custom bolt 330 may come in contact with the sprocket threads 460 of the interior bore 450 of the pin puller wrench 190. As shown in FIG. 11, the pin puller wrench 190 may then be torqued until the pin puller wrench 190 comes into contact with the inlet guide vane segment 90. As is shown in FIG. 12, the pin puller wrench 190 may be further torqued such the custom bolt 330 and the inlet guide vane segment pin 100 are completely withdrawn within the interior bore 450 of the pin puller wrench 190. The pin puller wrench 190 with the custom bolt 330 and the inlet guide vane segment pin 100 therein then may be removed. The process then may be repeated for the next inlet guide vane segment pin 100. Other and different components, configuration, and method steps may be used herein.

The inlet guide vane segment pin removal kit 170 thus permits the removal of the inlet guide vane segment pins 100 from the inlet guide vane segments 90 in a fast an efficient manner. The tools of the inlet guide vane segment pin removal kit 170 allow access to the inlet guide vane segment pins 100 despite the limited space between the inlet guide vane segment pins 100 and the rotor 45. The inlet guide vane segment pins 100 thus may be removed and replaced without removing the rotor 45 and the associated equipment. Avoidance of removing the rotor 45 results in significant savings in terms of time and money.

It should be apparent that the foregoing relates only to certain embodiments of this application and resultant patent. Numerous changes and modifications may be made herein by one of ordinary skill in the art without departing from the general spirit and scope of the invention as defined by the following claims and the equivalents thereof.

Further aspects of the invention are provided by the subject matter of the following clauses:
1. An inlet guide vane segment pin removal kit for removal of an inlet guide vane pin with a head having a recess therein from an inlet guide vane segment, comprising: a bolt; a first wrench for inserting the bolt into the recess of the inlet guide vane segment pin; and a second wrench with an interior bore such that torqueing the second wrench draws the bolt and the inlet guide vane segment pin into the interior bore.
2. The inlet guide vane segment pin removal kit of any preceding clause, wherein the inlet guide vane segment is attached to a lower half of an inner casing.
3. The inlet guide vane segment pin removal kit of any preceding clause, wherein the first wrench comprises a bolt insertion wrench for inserting the bolt into the recess of the inlet guide vane segment pin.
4. The inlet guide vane segment pin removal kit of any preceding clause, wherein the bolt comprises a first portion with first portion threads and a second portion with second portion threads.
5. The inlet guide vane segment pin removal kit of any preceding clause, wherein the bolt insertion wrench comprises an insertion socket and wherein the insertion socket is sized to accept the first portion of the bolt.
6. The inlet guide vane segment pin removal kit of any preceding clause, wherein the second portion threads of the second portion of the bolt are sized to accept threads of the recess of the inlet guide vane segment pin.
7. The inlet guide vane segment pin removal kit of any preceding clause, wherein the bolt insertion wrench comprises a body with a substantially curved shape.
8. The inlet guide vane segment pin removal kit of any preceding clause, wherein the body comprises a first sprocket, a second sprocket, and a chain therebetween.
9. The inlet guide vane segment pin removal kit of any preceding clause, wherein the second wrench comprises a pin puller wrench.
10. The inlet guide vane segment pin removal kit of any preceding clause, wherein the pin puller wrench comprises an interior bore.
11. The inlet guide vane segment pin removal kit of any preceding clause, wherein the interior bore comprises sprocket threads and wherein the sprocket threads are sized to accept the first portion threads of the first portion of the bolt.
12. The inlet guide vane segment pin removal kit of any preceding clause, wherein the interior bore is sized to accept the bolt and the inlet guide vane segment pin.
13. The inlet guide vane segment pin removal kit of any preceding clause, wherein the pin puller wrench comprises a body with a substantially curved shape.
14. The inlet guide vane segment pin removal kit of any preceding clause, wherein the body comprises a first sprocket, a second sprocket, and a chain therebetween.
15. A method of removing an inlet guide vane segment pin with a head having a recess therein from an inlet guide vane segment, comprising: inserting a bolt into the recess of the inlet guide vane segment pin; attaching a wrench with an interior bore to the bolt; and torqueing the wrench so as to drive the bolt and the inlet guide vane segment pin into the interior bore of the wrench.
16. An inlet guide vane segment pin removal kit for removal of an inlet guide vane pin with a head having a recess therein from an inlet guide vane segment, comprising: a bolt with a first portion and an second portion; a bolt insertion wrench for inserting the second portion of the bolt into the recess of the inlet guide vane segment pin; and a pin puller wrench with an interior bore sized to accept the first portion of the bolt such that torqueing the pin puller wrench draws the bolt and the inlet guide vane segment pin into the interior bore.
17. The inlet guide vane segment pin removal kit of any preceding clause, wherein the inlet guide vane segment is attached to a lower half of an inner casing.
18. The inlet guide vane segment pin removal kit of any preceding clause, wherein the bolt insertion wrench comprises an insertion socket and wherein the insertion socket is sized to accept the first portion of the bolt.
19. The inlet guide vane segment pin removal kit of any preceding clause, wherein the bolt insertion wrench comprises a first sprocket, a second sprocket, and a chain therebetween.
20. The inlet guide vane segment pin removal kit of any preceding clause, wherein the pin puller wrench comprises a first sprocket, a second sprocket, and a chain therebetween.

What is claimed is:

1. An inlet guide vane segment pin removal kit for removal of an inlet guide vane pin with a head having a recess therein from an inlet guide vane segment, comprising:
a bolt;
a first wrench for inserting the bolt into the recess of the inlet guide vane segment pin; and,
a second wrench with an interior bore such that torqueing the second wrench draws the bolt and the inlet guide vane segment pin into the interior bore.

2. The inlet guide vane segment pin removal kit of claim 1, wherein the inlet guide vane segment is attached to a lower half of an inner casing.

3. The inlet guide vane segment pin removal kit of claim 1, wherein the first wrench comprises a bolt insertion wrench for inserting the bolt into the recess of the inlet guide vane segment pin.

4. The inlet guide vane segment pin removal kit of claim 3, wherein the bolt comprises a first portion with first portion threads and a second portion with second portion threads.

5. The inlet guide vane segment pin removal kit of claim 4, wherein the bolt insertion wrench comprises an insertion socket and wherein the insertion socket is sized to accept the first portion of the bolt.

6. The inlet guide vane segment pin removal kit of claim 4, wherein the second portion threads of the second portion of the bolt are sized to accept threads of the recess of the inlet guide vane segment pin.

7. The inlet guide vane segment pin removal kit of claim 3, wherein the bolt insertion wrench comprises a body with a substantially curved shape.

8. The inlet guide vane segment pin removal kit of claim 7, wherein the body comprises a first sprocket, a second sprocket, and a chain therebetween.

9. The inlet guide vane segment pin removal kit of claim 4, wherein the second wrench comprises a pin puller wrench.

9. inlet guide vane segment pin removal kit of claim 9, wherein the pin puller wrench comprises an interior bore.

11. The inlet guide vane segment pin removal kit of claim 10, wherein the interior bore comprises sprocket threads and wherein the sprocket threads are sized to accept the first portion threads of the first portion of the bolt.

12. The inlet guide vane segment pin removal kit of claim 10, wherein the interior bore is sized to accept the bolt and the inlet guide vane segment pin.

13. The inlet guide vane segment pin removal kit of claim 9, wherein the pin puller wrench comprises a body with a substantially curved shape.

14. The inlet guide vane segment pin removal kit of claim 13, wherein the body comprises a first sprocket, a second sprocket, and a chain therebetween.

15. A method of removing an inlet guide vane segment pin with a head having a recess therein from an inlet guide vane segment, comprising:
inserting a bolt into the recess of the inlet guide vane segment pin;
attaching a wrench with an interior bore to the bolt; and,
torqueing the wrench so as to drive the bolt and the inlet guide vane segment pin into the interior bore of the wrench.

16. An inlet guide vane segment pin removal kit for removal of an inlet guide vane pin with a head having a recess therein from an inlet guide vane segment, comprising:
a bolt with a first portion and an second portion;
a bolt insertion wrench for inserting the second portion of the bolt into the recess of the inlet guide vane segment pin; and,
a pin puller wrench with an interior bore sized to accept the first portion of the bolt such that torqueing the pin puller wrench draws the bolt and the inlet guide vane segment pin into the interior bore.

17. The inlet guide vane segment pin removal kit of claim 16, wherein the inlet guide vane segment is attached to a lower half of an inner casing.

18. The inlet guide vane segment pin removal kit of claim 16, wherein the bolt insertion wrench comprises an insertion socket and wherein the insertion socket is sized to accept the first portion of the bolt.

19. The inlet guide vane segment pin removal kit of claim 16, wherein the bolt insertion wrench comprises a first sprocket, a second sprocket, and a chain therebetween.

20. The inlet guide vane segment pin removal kit of claim 16, wherein the pin puller wrench comprises a first sprocket, a second sprocket, and a chain therebetween.
